(19) United States
(12) Patent Application Publication
(10) Pub. No.: US 2006/0236820 A1
(43) Pub. Date: Oct. 26, 2006

(54) Self-adjusting pipe wrench for remote applications

(75) Inventors: Frank Hennessey, Harwood Heights, IL (US); Dennis Jarnecke, River Forest, IL (US); John Roxworthy, Chicago, IL (US); Angie Wood, Harwood Heights, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE

(21) Appl. No.: 11/289,049

(22) Filed: Nov. 29, 2005

Related U.S. Application Data
(60) Provisional application No. 60/675,040, filed on Apr. 26, 2005.

(51) Int. Cl. B25B 13/28

(52) U.S. Cl. 81/98; 81/99

(57) ABSTRACT

A self-adjusting wrench having an elongated drive handle (40) and an adjustable wrench assembly (10) connected with one end of the elongated drive handle. The adjustable wrench assembly includes a pair of opposed jaws (11, 12) disposed at an angle with respect to the longitudinal axis of the elongated drive handle.

### BACKGROUND OF THE INVENTION

This invention relates to a wrench, more particularly a pipe wrench that is self-adjusting and that is suitable for use in remote applications, such as a keyhole.

Gas utilities perform several operations on underground pipeline systems including the removal and installation of tee caps, insertion of couplings and pipeline surface preparations. When performed through a traditional bell hole, the performance of these operations generally does not represent a significant problem. For example, when removing and installing tee caps, workers are able to easily determine the cap size, type of cap and other physical attributes of the cap and are able to access the cap with cap-specific tools/accessories or with common adjustable tools. However, performance of these operations through a keyhole is substantially more problematic.

“Keyholing” and “potholing” refers to the excavation of a hole to access or repair utilities. Potholing and keyholing are preferred over other techniques such as digging shovels, backhoes, and the like which often result in damage to the utilities and the corresponding demand for expensive repair and reconstruction. In addition to the increased costs associated with damage repair and increased labor costs associated with digging, such damage may present danger to workers or others in the immediate vicinity of the excavation.

Typically, a keyhole is 12-18 inches in diameter and up to about ten feet in depth and visibility down the keyhole is limited, thereby precluding the use of conventional tools to access the utility. It is very difficult to determine the type of cap, fitting, or pipe, its exact size, and whether or not the workers have the proper equipment to perform the necessary work. In addition, the design of tee caps and fittings is not standardized between manufacturers, thereby making it very difficult to determine every variation in design and size and to have a specific tool or accessory for each. Often times the type of fitting or size of pipe is not known until it is unearthed. Thus, to be equipped for every possible design and size would require an excessive amount of tools and accessories on the crew truck. In addition, due to the relatively small amount of space in keyholes in which to work, tool control and maneuverability can be problematic.

### SUMMARY OF THE INVENTION

Accordingly, it is one object of this invention to provide a wrench that is suitable for use in remote applications.

It is one object of this invention to provide a wrench that addresses some of the problems associated with the use of conventional tools in keyhole applications.

It is one object of this invention to provide a wrench for use in keyhole applications that is readily adaptable to the design and size of any tee cap, pipe, and fitting.

These and other objects of this invention are addressed by a self-adjusting type wrench comprising a rigid adapter body comprising a heel jaw, a hook jaw disposed opposite the heel jaw and pivotably connected with the rigid adapter body such that the hook jaw is pivotable within the plane of the heel jaw, adjustment means for automatically adjusting the distance between the heel jaw and the hook jaw, and a removable elongated drive handle connected with the rigid adapter body such that rotation around a longitudinal axis of the handle results in application of a force on an object disposed between the heel jaw and the hook jaw. In accordance with one embodiment of this invention, at least one of the heel jaw and the hook jaw comprises a plurality of grasping teeth.

### BRIEF DESCRIPTION OF THE DRAWINGS

These and other objects and features of this invention will be better understood from the following detailed description taken in conjunction with the drawings wherein:

FIG. 1 is a perspective view of the self-adjusting wrench assembly in accordance with one embodiment of this invention;

FIG. 2 is a perspective view of the hook jaw of the self-adjusting wrench in accordance with one embodiment of this invention;

FIG. 3 is a perspective view of the connection end of the drive handle for the self-adjusting wrench in accordance with one embodiment of this invention;

FIG. 4 is a perspective view of the self-adjusting wrench with the drive handle connected with the self-adjusting wrench assembly in accordance with one embodiment of this invention;

FIG. 5 is a diagram showing the torsion spring for applying a pivotable force on the heel jaw of the self-adjusting pipe wrench in accordance with one embodiment of this invention; and

FIG. 6 is a perspective view of a fully assembled self-adjusting pipe wrench in accordance with one embodiment of this invention.

### DETAILED DESCRIPTION OF THE PRESENTLY PREFERRED EMBODIMENTS

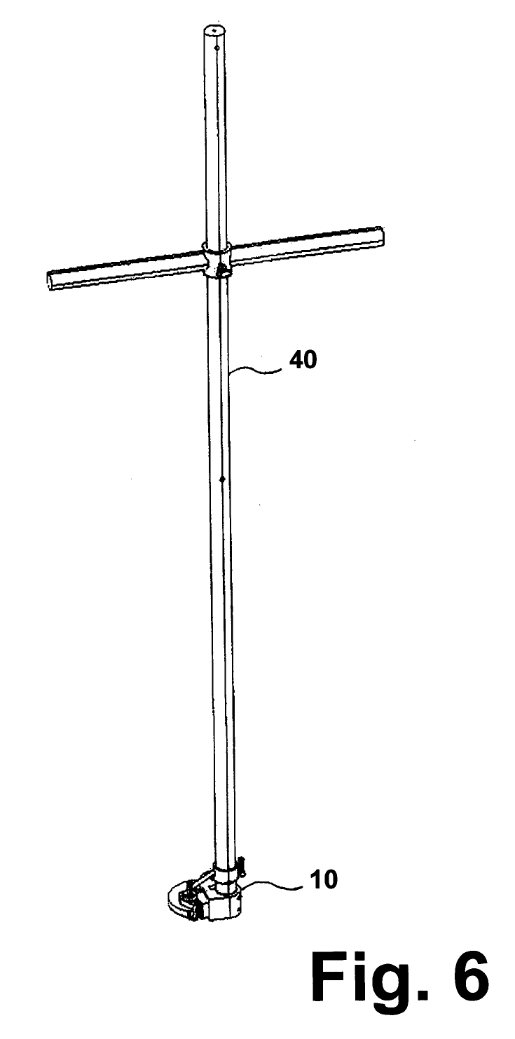

A fully assembled self-adjusting wrench in accordance with one embodiment of this invention is shown in FIG. 6. As shown therein, the wrench comprises two basic elements, an elongated drive handle 40 and a grasping element or self-adjusting wrench assembly 10.

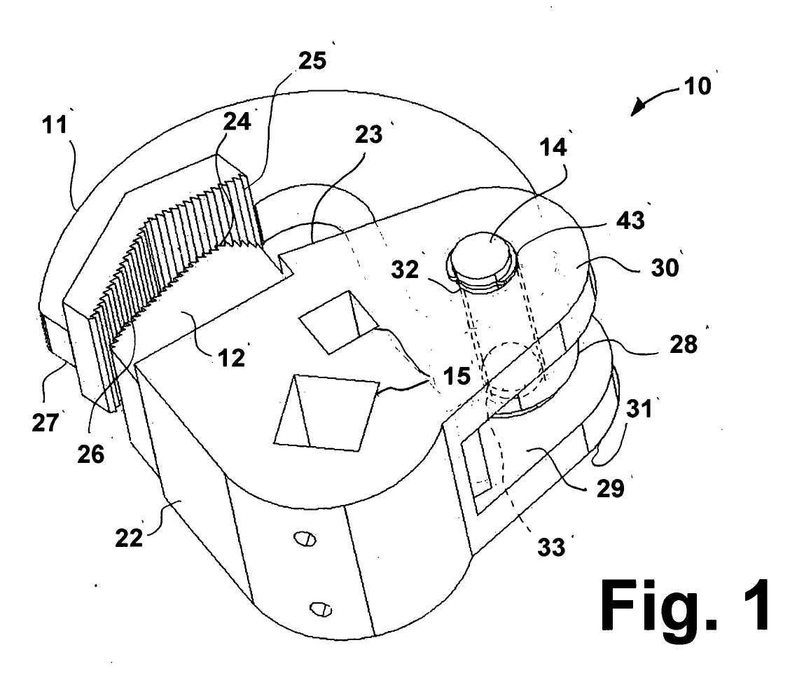

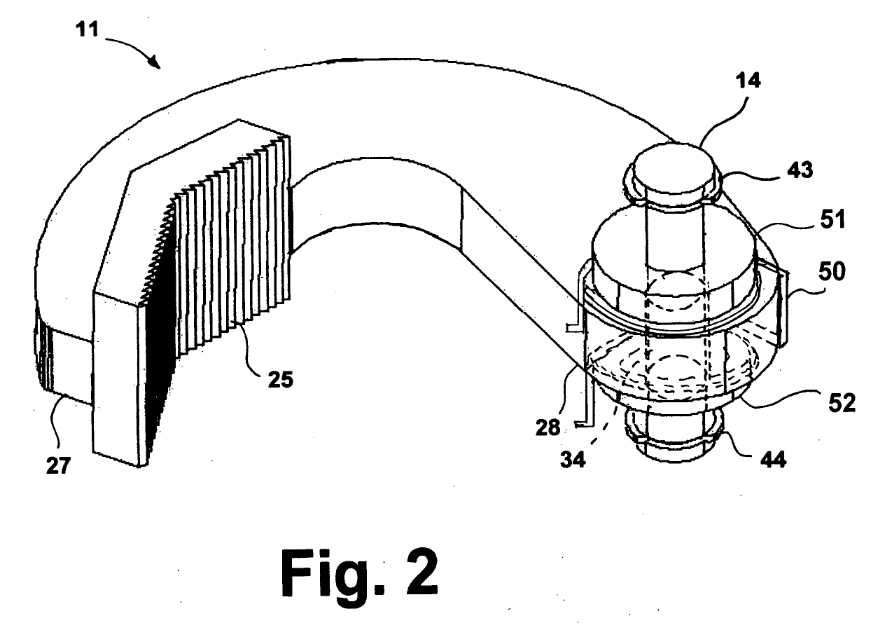

Referring to FIGS. 1 and 2, the self-adjusting wrench assembly 10 comprises a rigid adapter body 22 having a heel jaw 12 and a hook jaw 11 pivotably connected to rigid adapter body 22 by pivot means for pivoting hook jaw 11. Rigid adapter body 22 in accordance with one embodiment of this invention is a substantially planar structure of a given thickness having a grasping section 23 disposed along one side and having a pivoting section at a distance from grasping section 23. Grasping section 23 comprises heel jaw 12, which comprises a grasping surface 24 facing outwardly from grasping section 23. In accordance with one embodiment of this invention, heel jaw 12 comprises a plurality of grasping teeth 26 disposed along grasping surface 24.

Hook jaw 11 is a substantially planar hook-shaped structure of a given thickness having a grasping end 27 and a pivot end 28. Grasping end 27 comprises hook jaw grasping surface 25 facing grasping section 23 of heel jaw 12. In accordance with one embodiment of this invention, grasping surface 25 forms a plurality of grasping teeth.

The thickness of hook jaw 11, in accordance with one embodiment of this invention as shown in FIG. 1, is less than the thickness of rigid adapter body 22. However, hook jaw grasping surface 25 has a thickness substantially corresponding to the thickness of grasping surface 24 of heel jaw 12. Pivot end 28 of hook jaw 11 is pivotably connected with the pivoting section of rigid adapter body 22, whereby hook jaw 11 is pivotable in a plane substantially parallel to planar surfaces 30, 31 of rigid adapter body 22. In the embodiment shown in FIG. 1, the pivoting section forms a laterally oriented U-shaped channel 29 between planar surfaces 30, 31 of rigid adapter body 22, which U-shaped channel 29 has a width sufficient to receive pivot end 28 of hook jaw 11. Planar surfaces 30, 31 form a pair of aligned bores 32, 33 sized to accommodate pivot pin 14. Pivot end 28 of hook jaw 11 forms hook jaw bore 34, as shown in FIG. 2, alignable with aligned bores 32, 33 and sized to accommodate pivot pin 14. Pivot pin 14 is held in place on opposing sides of rigid adapter body 22 by retaining rings 43, 44.

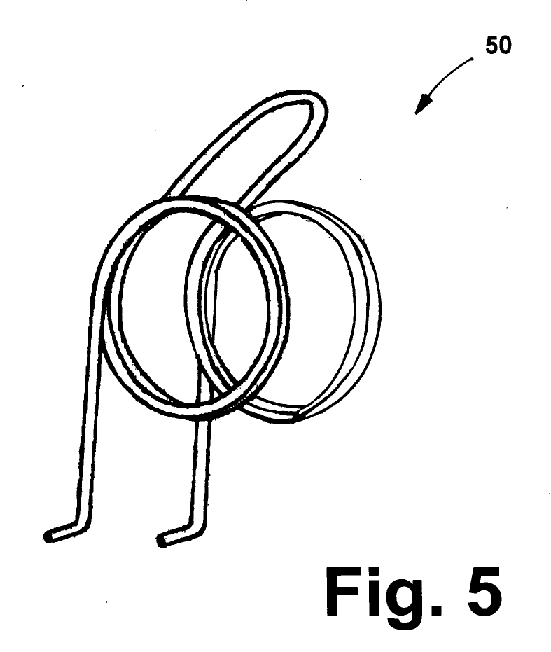

The self-adjusting feature of the self-adjusting wrench of this invention is provided, in accordance with one embodiment of this invention, by torsion spring 50 shown in FIG. 5. In accordance with one embodiment of this invention, pivot end 28 of hook jaw 11 forms raised shoulders 51, 52 around bore 34. It will be apparent to those skilled in the art that, shoulders 51, 52 may just as easily be formed as part of rigid adapter body 22 within U-shaped channel 29, and such embodiment is deemed to be within the scope of this invention. As shown in FIG. 2, torsion spring 50 is circumferentially disposed around shoulders 51, 52, oriented to exert a force against a pivoting of hook jaw 11 around pivot pin 14 in a direction away from heel jaw 12.

Rigid adapter body 22 forms at least one polygonal bore 15, which is adapted to receive a correspondingly shaped end 17 of the elongated drive handle 40. In accordance with one embodiment of this invention, the at least one polygonal bore is oriented substantially perpendicular to the plane of planar surfaces 30, 31. In accordance with one preferred embodiment of this invention, the at least one polygonal bore has a square shape, thereby rendering it suitable for receiving common square drives and allowing the self-adjusting wrench assembly to be used as an attachment to long handled keyhole tools or even common hand tools that can accept a square drive socket. In accordance with one preferred embodiment of this invention, rigid adapter body 22 forms at least one polygonal bore on opposed sides of the rigid adapter body to which the elongated drive handle 40 may be attached, thereby enabling the wrench to be used in either a tightening or loosening mode. That is, when used in a tightening mode, elongated drive handle 40 is inserted into a bore on one side of rigid adapter body 22 and, when used in a loosening mode, the elongated drive handle is inserted into the bore on the opposite side of the rigid adapter body.

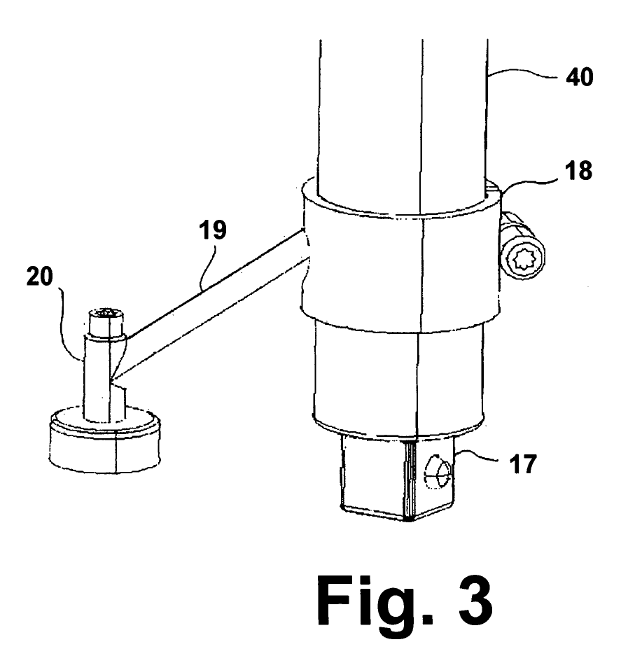

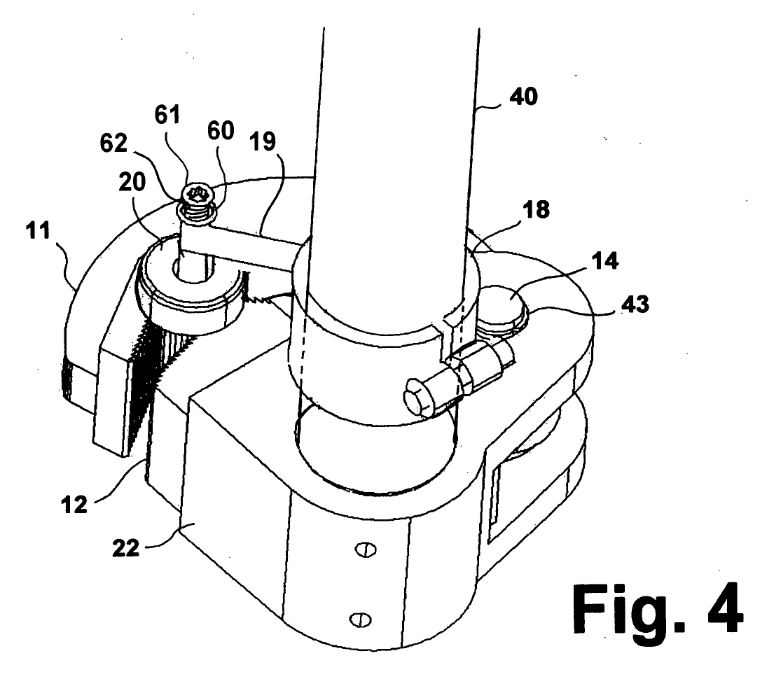

The self-adjusting wrench of this invention can be used in different axes with respect to the axis of the pipeline on which work is being performed. The two most common axes are the vertical axis (substantially perpendicular to the axis of the pipeline) or in the horizontal axis (substantially parallel to the axis of the pipeline). To facilitate use in the vertical axis in accordance with one embodiment of this invention, the self-adjusting wrench comprises a laterally extending retaining element 20 connected with said elongated drive handle 40 proximate rigid adapter body 22 by rotation means for rotating the retaining element around the longitudinal axis of the elongated drive handle. The retaining element, as shown in FIG. 3, provides support for the keyhole tool, eliminating or substantially reducing the force required by the operator to hold the tool in a constant vertical position by counteracting gravity, that is, preventing it from slipping down off a fitting. In accordance with one embodiment of this invention, retaining element 20 is attached by means of an adjustable collar 18 and a laterally extending arm 19 to the elongated drive handle 40. Preferably, retaining element 20 is vertically adjustable to enable accommodation of a variety of sizes of caps, pipes, and fittings. Vertical adjustment of retaining element 20 may be accomplished in a variety of ways. In accordance with one embodiment of this invention, laterally extending arm 19 is hingedly or pivotably connected with adjustable collar 18. In accordance with another embodiment of this invention, retaining element 20 is connected to the end of arm 19 distal from adjustable collar 18 in a manner which permits vertical movement of retaining element 20. In accordance with one embodiment of this invention, the distal end of arm 19 forms a horizontally oriented opening 60 as shown in FIG. 4 and retaining element 20 comprises an upwardly extending stem 61, which extends through opening 60. Stem 61 is sized with respect to opening 60 to permit substantially free vertical movement of retaining element 20. In accordance with one embodiment of this invention, a spring 62 disposed around stem 61 controls vertical movement of retaining element 20. In accordance with one embodiment, the retaining element 20 comprises a magnet, thereby enabling retention of a cap/fitting of ferrous composition within the wrench jaws.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. A self-adjusting wrench comprising:
a rigid adapter body comprising a heel jaw and forming at least one polygonal bore at an angle with respect to a plane of said heel jaw;
a hook jaw disposed opposite said heel jaw, said hook jaw pivotably connected with said rigid adapter body and adapted to pivot in said plane of said heel jaw;
adjustment means for automatically adjusting a distance between said heel jaw and said hook jaw; and
a removable elongated drive handle having a connection end connected with said rigid adapter body, said connection end having a shape corresponding to said at least one polygonal bore and sized to fit snugly within said at least one polygonal bore.

2. A self-adjusting wrench in accordance with claim 1, wherein at least one of said heel jaw and said hook jaw comprises a plurality of teeth on an opposed jaw-facing surface.

3. A self-adjusting wrench in accordance with claim 1 further comprising a laterally extending retaining element connected with said removable elongated drive handle.

4. A self-adjusting wrench in accordance with claim 1, wherein said adjustment means comprises a torsion spring connected with one of said rigid adapter body and said hook jaw and oriented to exert a force against a pivoting of said hook jaw around a hook jaw pivot point away from said heel jaw.

5. A self-adjusting wrench in accordance with claim 3, wherein said laterally extending retaining element is connected with said removable elongated drive handle by rotation means for enabling rotation of said laterally extending retaining element around a longitudinal axis of said removable elongated drive handle.

6. A self-adjusting wrench in accordance with claim 5, wherein said rotation means comprises an adjustable collar disposed around said removable elongated drive handle.

7. A self-adjusting wrench in accordance with claim 6, wherein said laterally extending retaining element comprises an arm outwardly extending from said removable elongated drive handle having one end connected with the adjustable collar and having an opposite end movably connected with a retention tool, said retention tool comprising contact means for maintaining a workpiece in contact with said wrench.

8. A self-adjusting wrench in accordance with claim 7, wherein said contact means comprises a magnet.

9. A self-adjusting wrench in accordance with claim 1, wherein said at least one polygonal bore is disposed at a 90° angle with respect to said plane of said heel jaw.

10. A self-adjusting wrench comprising:
an elongated drive handle; and
an adjustable wrench assembly connected with one end of said elongated drive handle, said adjustable wrench assembly comprising a pair of opposed jaws disposed at an angle with respect to the longitudinal axis of said elongated drive handle.

11. A self-adjusting wrench in accordance with claim 10, wherein said angle is 90°.

12. A self-adjusting wrench in accordance with claim 10, wherein said adjustable wrench assembly is removably connected with said elongated drive handle.

13. A self-adjusting wrench in accordance with claim 12, wherein said adjustable wrench assembly forms at least one polygonal bore adapted to receive said one end of said elongated drive handle.

14. A self-adjusting wrench in accordance with claim 10, wherein said adjustable wrench assembly comprises adjustment means for automatically adjusting a distance between said opposed jaws.

15. A self-adjusting wrench in accordance with claim 10 further comprising a workpiece retainer connected with said elongated drive handle, said workpiece retainer comprising retention means for maintaining a contact between a workpiece and said adjustable wrench assembly.

16. A self-adjusting wrench in accordance with claim 15, wherein said retention means comprises a magnet.
